(19) United States
(12) Patent Application Publication
(10) Pub. No.: US 2009/0124678 A1
(43) Pub. Date: May 14, 2009

(54) Combined Use of Metconazole and Epoxiconazole for Reducing or Preventing the Contamination of Cereals With Mycotoxins

(76) Inventors: Martin Semar, Gleiszellen-Gleishorbach (DE); Thomas Christen, Dannstadt (DE); Maria Scherer, Landau (DE); Reinhard Stierl, Freinsheim (DE); Siegfried Strathmann, Limburgerhof (DE); Ulrich Schofl, Bruhl (DE); John Bedford, Re Bollington (GB)

Correspondence Address: BIRCH STEWART KOLASCH & BIRCH, PO BOX 747, FALLS CHURCH, VA, 22040-0747, US

(21) Appl. No.: 11/988,690

(22) PCT Filed: Jul. 17, 2006
(86) PCT No.: PCT/EP2006/064322

§ 371 Date: Jan. 11, 2008

(30) Foreign Application Priority Data
Jul. 18, 2005 (DE) 10 2005 033 433.4

(51) Int. Cl. A01N 43/653; A01P 3/00

(52) U.S. Cl. 514/383

(57) ABSTRACT

The invention relates to the combined use of metconazole and epoxiconazole for reducing or preventing the contamination of cereals with mycotoxins formed by mould fungus producing trichothecene.

The present invention relates to the combined use of metconazole and epoxyconazole for reducing or preventing the contamination of cereal with mycotoxins formed by trichothecene-producing mold fungi.

The harvested material of all cereal species, such as wheat, barley, rye, triticale, oats, rice and corn, and also that of many other plant species, can be contaminated with trichothecene toxins and other mycotoxins which originate from trichothecene-producing mold fungi. Most highly affected are triticale, oats, common wheat and in particular durum wheat. The sources of these toxins are certain fungi, for example those of the genera Trichoderma, Stachybotrys and in particular Fusarium, infecting these plants. All over the world, such fusarioses are important cereal diseases which, in addition to the classic wheat-growing regions in the USA and Canada, also affect Australia and Europe. The Fusarium fungus is mainly soil-dwelling, degrading, together with other microorganisms, plant material. It can exist on living and dead material alike. A more frequent occurrence as cereal disease is promoted by a number of factors:
Fusarium-infested organic matter on/in the soil (as inoculum), the contamination being promoted in particular by corn stubbles and residual corn straw (see, for example, A. Meier, B. Birzele, E. Oerke, U. Steiner, J. Krämer and H. Dehne, “Significance of different inoculum source for the Fusarium infection of wheat ears.”, Mycotoxin Research 1, 2001, 71-75)
sufficient moist-warm weather in spring and early summer, allowing the fungus to form sporangia
alternating periods of precipitation and sunshine for spreading the spores
flowering of the plant (especially cereal) during the period when the spores are airborne (see, for example, A. Obst, V. H. Paul, “Krankheiten und Schädlinge des Getreides” [cereal diseases and cereal pests], Verlag Th. Mann, Gelsenkirchen-Buer, 1993).

The infection of cereal with Fusarium fungi results in a characteristic ear infection where individual ears are bleached and in some cases a reddish spore coating can be observed. In most cases, the ears dry out above the infected site, and only shriveled grain is formed there. It may well be possible that normally sized grains mature below the infected site; however, these are generally contaminated by fungus toxins. Therefore, Fusarium fungi may not only reduce the yields, but, in particular, they also contaminate the harvested cereal with mycotoxins. Contamination of the cereal grains may take place both in the ear and, less commonly, during storage of the harvested material.

Following ingestion of contaminated plants and parts of plants, for example of cereal or products prepared therefrom, even minute doses of the mycotoxins contained therein may cause serious acute or chronic diseases in humans and animals. Acute adverse effects of trichothecene toxins and other mycotoxins originating from trichothecene-producing fungi on health can manifest themselves in a large number of symptoms, for example in a compromised immune system, an IgA nephropathy (Berger's Disease), nausea, kidney damage, feed refusal and vomiting in domestic animals and reduced laying performance in poultry breeding. Moreover, in humans and animals these mycotoxins have estrogenic and/or mutagenic activity (see, for example, “Mykotoxine und ihr Einfluss auf die Immunreaktionen” [Mycotoxins and their effect on the immune response], H. Köhler, Bundesinstitut für gesundheitlichen Verbraucherschutz und Veterinärmedizin, Fachbereich 4, Jena, which can be found, for example, under http://www.bgvv.de/sixcms_upload/media/98/koehler.pdf). In the case of bolus wheat, there is suspected to be a connection between the contamination with such toxins and the frothing over of the beer (P. Gjersten, “Gushing in Beer: Its nature, cause and prevention”, Brewers Digest 42, 1967, 80-84).

To avoid an adverse effect on health by ingestion of the abovementioned mycotoxins, national and supranational authorities have laid down which maximum amounts of mycotoxins are tolerable. Thus, the Committee on Food of the EU recommends 0.001 mg of DON (deoxynivalenol; a trichothecene toxin) per kilogram of body weight as TDI (Tolerable Daily Intake) for adults. According to the German regulation on maximum amounts of mycotoxins, cereal grains for direct consumption and in processed cereal products may contain at most 0.5 mg of DON per kilogram of cereal used. In bakersware and pastry, the DON contents must not exceed 0.35 mg/kg, whereas the upper limit in food for babies and infants is 0.1 mg/kg (see, for example, “Mykotoxine und ihr Einfluss auf die Immunreaktionen”, H. Köhler, Bundesinstitut für gesundheitlichen Verbraucherschutz und Veterinärmedizin, Fachbereich 4, Jena, which can be found, for example, under http://www.bgvv.de/sixcms_upload/media/98/koehler.pdf; moreover regulation on maximum amounts of mycotoxins in food (Mykotoxin-Höchstmengenverordnung, MHmV) dated Jun. 2, 1999, Bundesgesetzblatt, volume 1999, part 1, No. 29, page 1248)

To reduce the content of the abovementioned mycotoxins in plants and plant parts and the food products and animal feed obtained therefrom, the measures currently employed are essentially the following:
cultivation of cultivars with low susceptibility for Fusarium infection;
suitable crop rotation; in particular avoidance of corn as previous crop;
turning pillage, especially if the previous crop was corn;
storage conditions which prevent the development of Fusarium fungi.

However, these purely preventative measures are not yet satisfactory and are not reliably effective, in particular when the prevailing weather conditions favor infection by mold fungi.

EP-A-0769906 describes in a general form the use of metconazole in combination with a further triazole fungicide for controlling harmful fungi in plants and plant products. The composition is used in particular for controlling harmful fungi in wood and timber products and also in textiles.

There is a need for the more effective reduction or prevention of contamination of plants and plant products intended for human and animal consumption and in particular of cereal with trichothecene toxins and other toxins originating from trichothecene-forming fungi.

Accordingly, it was an object of the present invention to provide compounds reducing or preventing the contamination of cereal with toxins formed by trichothecene-producing fungi.

Surprisingly, it has been found that the joint use of metconazole and epoxyconazole reduces or prevents the contamination of cereal with such toxins.

Accordingly, the object was achieved by using metconazole in combination with epoxyconazole for reducing or preventing the contamination of cereal with toxins formed by trichothecene-producing fungi.

On the one hand, the combined use of metconazole and epoxyconazole may consist in using a composition comprising these two active compounds.

Accordingly, the invention also provides the use of a composition comprising metconazole and epoxyconazole for reducing or preventing the contamination of cereal with toxins formed by trichothecene-producing fungi.

On the other hand, the combined use of metconazole and epoxyconazole may also consist in using the two active compounds separately, but within a short time of one another. More detailed illustrations of the combined use of metconazole and epoxyconazole can be found in the specifications below.

The toxins formed by trichothecene-producing fungi are both trichothecenes and toxins different therefrom originating from the same mold fungi.

The trichothecene-producing fungi are preferably those from the genera Trichoderma, Stachybotrys and, in particular, Fusarium.

Of importance in connection with the mycotoxin production are various Fusarium fungi, for example: F. culmorum and F. graminearum as most important species (Mauler-Machnik A. & Suty A, 2000: Aktueller Stand der internationalen Forschung zur Bekämpfung von Ährenfusariosen in Weizen [Current state of International Research on the control of ear fusarioses in wheat]. 22. Mycotoxin Workshop, Bonn, Jun. 5-7, 2000), and furthermore also F. acuminatum, F. avenaceum, F. crockwellense, F. equiseti, F. moniliforme, F. oxysporum, F. poae, F. proliferans, F. scirpi, F. sporotrichioides, F. subglutinans and F. tricinctum. (H. Schnerr, “Quantitativer Nachweis von Deoxynivalenol und Trichothecene-bildenden Fusarium spp. mit Biosensor und PCR in Getreide” [Quantitative detection of deoxynivalenol and trichothecene-forming Fusarium spp. using a biosensor and PCR in cereal], Ph D thesis, 2002, Technische Universität München; W. F. O. Marasas, P. E. Nelson and T. A. Toussoun, Fusarium species: Identity and mycotoxicology, The Pennsylvania State University Press, 1984, University Park and London; L. Niessen and R. F. Vogel, Group-specific PCR-Detection of Potential Trichothecene-Producing Fusarium Species in Pure Cultures and Cereal Samples, System. Appl. Microbiol., 1998, 21:618-631; A. Bottalico, Fusarium diseases of cereals: Species complex and related mycotoxin profiles in Europe, J. Plant Pathol. 1998, 80:85-103).

In the case of the genus Trichoderma, it is in particular the representative Trichoderma viride which is of importance in this context. The mold fungi of the genus Stachybotrys are in particular Stachybotrys chartarum.

The trichothecene-producing fungi are in particular representatives of the genus Fusarium.

The mycotoxins are preferably trichothecenes or zearalenone.

Zearalenone is a mycotoxin with estrogen action which is formed by various species of the genus Fusarium. Preferred substrates of the zearalenone-forming fungi are corn and oats. However, other cereal species may also be heavily infected. Since zearalenone is formed in a very late development phase of the fungus, it is found especially in highly infected cereal. Zearalenone has no acute toxicity; however, it is presumed to have carcinogenic action. In grazing animals, it causes fertility disorders, premature births and stillbirths (see, for example, H. Schnerr, “Quantitativer Nachweis von Deoxynivalenol und Trichothecene-bildenden Fusarium spp. mit Biosensor und PCR in Getreide”, PhD thesis, 2002, Technische Universität München; “Mykotoxine und ihr Einfluss auf die Immunreaktionen”, H. Köhler, Bundesinstitut für gesundheitlichen Verbraucherschutz und Veterinärmedizin, Fachbereich 4, Jena, which can be found, for example, under http://www.bgvv.de/sixcms_upload/media/98koehler.pdf).

The name trichothecene refers to a group of about 100 mycotoxins formed in particular by fusaria, but also by other mold fungi on plants and plant products, in particular on cereal and cereal products. Trichothecenes have a broad spectrum of biological actions. In general, trichothecenes inhibit the protein biosynthesis in mammalian cells, sometimes even at concentrations as low as 1 ng. Trichothecene poisoning causes vomiting, diarrhea, food refusal, inflammations of the gastrointestinal tract, damage to nerve cells, heart muscle, lymph system, testes, thymus and development of tissue necroses. Poisonings of animals and humans are known, for example, under the term “moldy corn toxicosis” (USA), “bean hull toxicosis” (Japan) or “alimentary toxic aleukia” (CIS). According to their chemical structure, the trichothecenes are divided into groups A to D.

Of importance are in particular the following trichothecene toxins: T-2 toxin, HT-2 toxin, neosolaniol, monoacetoxyscirpenol, diacetoxyscirpenol (DAS), 15-acetoxyscirpendiol, deoxynivalenol (DON=vomitoxin), nivalenol, 3-acetoxynivalenol, 15-acetoxynivalenol, fusarenone, T-2 tetraol and verrucarol.

The mycotoxins are in particular deoxynivalenol (DON).

The cereal is, for example, wheat, rice, corn, barley, oats, triticale and rye. In the context of the present invention, the term “cereal” denotes both the plant itself and its harvested product, such as cereal grains or, in the case of corn, also the corncob.

With particular preference, the cereal is selected from wheat, such as durum wheat or common wheat.

The combination of metconazole and epoxyconazole is used in particular for reducing or preventing the contamination of wheat with deoxynivalenol (DON).

Metconazole and epoxyconazole are known conazole fungicides of the triazole type and have the following structural formulae (I=metconazole; II=epoxyconazole):

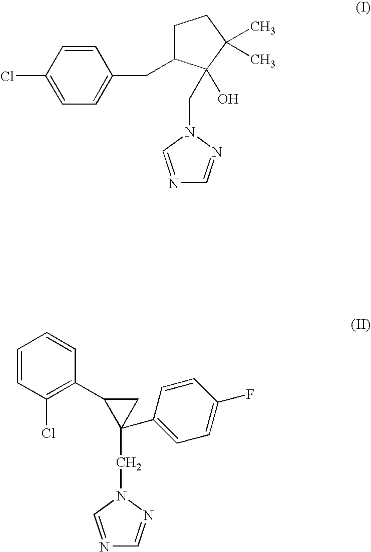

These compounds can be employed in the composition both as free bases and as salts. The salts are obtained from the free form by reaction with an acid. Suitable acids include, for example, mineral acids, such as hydrofluoric acid, hydrochloric acid, hydrobromic acid, sulfuric acid, nitric acid and phosphoric acid, and also organic acids, such as acetic acid, hydroxyacetic acid, propionic acid, methanesulfonic acid, benzenesulfonic acid and the like.

The two active compounds (I) and (II) and especially their salts can also be used according to the invention in the form of their solvates, for example as hydrates or alcoholates.

Moreover, the compounds (I) and (II) can be employed both as pure stereoisomers and in the form of stereoisomer mixtures. Here, the term stereoisomerism relates to Z/E isomers which, in the case of metconazole, are due to the relative position of the substituents in the 1,5-position on the cyclopentane ring and, in the case of epoxyconazole, due to the relative position of the substituents in the 2,3-position on the oxirane ring.

Furthermore both the individual enantiomers and enantiomer mixtures of the respective Z and E isomers of (I) and/or (II) can be used.

Metconazole and epoxyconazole are employed in a ratio such that there is a synergistic effect of this combination with respect to the reduction or prevention of the contamination of cereal with the mycotoxins mentioned. Preferably, the ratio of metconazole to epoxyconazole is from 20:1 to 1:20, particularly preferably from 10:1 to 1:10, more preferably from 5:1 to 1:5 and in particular from 2:1 to 1:3, for example from 1:1 to 1:2.

The combination of metconazole and epoxyconazole, used according to the invention for reducing or preventing contamination with the mycotoxins mentioned above, is generally employed by treating the cereal or plant parts thereof or the cereal products with a combination of these active compounds. The treatment of the cereal or the cereal products is preferably carried out by bringing the cereal or plant parts thereof or the cereal product into contact with both active compounds or with a composition comprising the two active compounds. For this purpose, the composition or the individual active compounds is/are applied to the cereal or to plant parts thereof or to the cereal product. The two active compounds metconazole and epoxyconazole can therefore be applied in a mixture or separately. In the case of separate application, the individual active substances can be applied simultaneously or—as part of a treatment sequence—staggered in succession, where in the case of successive application the application is preferably within an interval of a few seconds to several days, for example of a few seconds to 14 days or of a few seconds to 7 days. Here, the individual active compounds and also the composition comprising them are generally employed in a formulation typical for the crop protection field. More details are given below.

The treatment of the cereal or of plant parts thereof or of the cereal products can be both protective and curative, i.e. before or after an infection with harmful fungi. It is preferably carried out as close in time as possible to the infection event, i.e. before or after the infection at a point in time which is as close as possible to the infection.

The timing of the application, the number of applications and the application rates employed in each case have to be adapted to the prevailing conditions and have to be determined for each individual case by a person skilled in the art.

The active compounds can be applied as such or in the form of their formulations or in the form of the use forms prepared therefrom, by spraying, atomizing, dusting, broadcasting or watering. The use forms depend entirely on the intended purposes, especially on the species and cultivar of cereal and on the cereal product to which they are to be applied; in each case, the finest possible distribution of the active compounds employed according to the invention and also of the auxiliaries should be ensured.

Metconazole and epoxyconazole and compositions comprising a combination of these two active compounds are typically employed as formulations customary in the field of crop protection and the protection of materials.

Customary formulations are, for example, solutions, emulsions, suspensions, dispersions, pastes, dusts, materials for broadcasting, powders and granules.

The formulations are prepared in a known manner, for example by extending the active compound with solvents and/or carriers, if desired with the use of emulsifiers and dispersants. Solvents/auxiliaries suitable for this purpose are essentially:
Water, aromatic solvents (for example Solvesso products, xylene), paraffins (for example mineral oil fractions), alcohols (for example methanol, butanol, pentanol, benzyl alcohol), ketones (for example cyclohexanone, gamma-butyrolactone), pyrrolidones (NMP, NOP), acetates (glycol diacetate), glycols, dimethyl fatty amides, fatty acids and fatty esters. In principle, it is also possible to use solvent mixtures.
Carriers, such as natural ground minerals (for example kaolins, clays, talc, chalk) and synthetic ground minerals (for example finely divided silica, silicates).
Surfactants, such as alkali metal, alkaline earth metal and ammonium salts of aromatic sulfonic acids, for example lignosulfonic acid, phenolsulfonic acid, naphthalenesulfonic acid and dibutylnaphthalenesulfonic acid, and also fatty acids, alkylarylsulfonates, alkyl sulfates, alkylsulfonates, fatty alcohol sulfates, fatty acids and sulfated fatty alcohol glycol ethers, furthermore condensates of sulfonated naphthalene and naphthalene derivatives with formaldehyde, condensates of naphthalene or of naphthalenesulfonic acid with phenol and formaldehyde, polyoxyethylene octylphenol ether, ethoxylated isooctyl phenol, octyl phenol or nonyl phenol, alkylphenol polyglycol ethers, tributylphenyl polyglycol ether, tristearylphenyl polyglykol ether, alkylaryl polyether alcohols, isotridecyl alcohol, alcohol and fatty alcohol/ethylene oxide condensates, ethoxylated castor oil, polyoxyethylene alkyl ethers or polyoxypropylene alkyl ethers, ethoxylated polyoxypropylene, lauryl alcohol polyglycol ether acetate, sorbitol esters, lignosulfite waste liquors, methylcellulose or siloxanes. Suitable siloxanes are, for example, polyether/polymethylsiloxane copolymers, which are also referred to as “spreaders” or “penetrants”.

Inert formulation auxiliaries suitable in particular for preparing directly sprayable solutions, emulsions, pastes or oil dispersions are essentially: mineral oil fractions of medium to high boiling point, such as kerosene or diesel oil, furthermore coal tar oils and oils of vegetable or animal origin, aliphatic, cyclic and aromatic hydrocarbons, for example toluene, xylenes, paraffins, tetrahydronaphthalene, alkylated naphthalenes or derivatives thereof, alcohols, such as methanol, ethanol, propanol, butanol and cyclohexanol, ketones, such as cyclohexanone and isophorone, strongly polar solvents, for example dimethyl sulfoxide, N-methylpyrrolidone or water.

Powders, materials for broadcasting and dusts can be prepared by mixing or jointly grinding the active substances with a solid carrier.

Granules, for example coated granules, impregnated granules and homogeneous granules, can be prepared by binding the active compounds to solid carriers.

Solid carriers are, for example, mineral earths, such as silica gels, silicates, talc, kaolin, attaclay, limestone, lime, chalk, bole, loess, clay, dolomite, diatomaceous earth, calcium sulfate and magnesium sulfate, magnesium oxide, ground synthetic materials, fertilizers, such as, for example, ammonium sulfate, ammonium phosphate, ammonium nitrate, ureas and vegetable products, such as cereal meal, tree bark meal, wood meal and nutshell meal, cellulose powders and other solid carriers.

The formulations generally comprise metconazole, epoxyconazole or their mixture in a total amount of from 0.01 to 95% by weight, preferably from 0.1 to 90% by weight, based on the total weight of the formulation.

Products (formulations) for dilution with water are, for example, water-soluble concentrates (SL), dispersible concentrates (DC), emulsifiable concentrates (EC), emulsions (EW, EO), suspensions (SC, OD), water-dispersible and water-soluble granules (WG, SG) and also water-dispersible and water-soluble powders (WP, SP). Products (formulations) for direct application are, for example, dusts (DP), granules (GR, FG, GG, MG) and ULV solutions (UL).

Aqueous use forms can be prepared from storage-stable formulations, such as concentrated solutions, emulsion concentrates, suspensions, pastes, wettable powders (spray powders, oil dispersions) or water-dispersible granules, by addition of water, and they can be applied, for example, by spraying.

To prepare emulsions, pastes or oil dispersions, metconazole and epoxyconazole as such or dissolved in an oil or solvent can be homogenized in water using wetting agents, adhesives, dispersants or emulsifiers. However, it is also possible to prepare concentrates from the active substance and wetting agent, tackifier, dispersant or emulsifier and, if appropriate, solvent or oil, which concentrates are suitable for dilution with water. Naturally, the use forms will comprise the auxiliaries used in the storage-stable formulations.

The active compound concentrations in preparations diluted with water may vary within relatively wide ranges. In general, they are between 0.0001 and 10% by weight, preferably between 0.01 and 1% by weight.

Oils of various types, wetting agents, adjuvants, herbicides, further fungicides, insecticides, bactericides, growth regulators or else fertilizers can be added to the active compounds, if appropriate even immediately prior to application (tank mix). These agents can be added to the fungicides used according to the invention in a weight ratio of from 1:10 to 10:1.

The combined use of metconazole and epoxyconazole with one or more active compounds customary in crop protection, for example with further fungicides, can take place either by using a mixture of these active compounds (for example a joint formulation or a tank mix) or by successive application of the individual active compounds.

The following list of fungicides with which the compounds (I) and (II) to be used according to the invention can be applied jointly is intended to illustrate the possible combinations, but not to limit them:
acylalanines, such as benalaxyl, metalaxyl, ofurace, oxadixyl,
amine derivatives, such as aldimorph, dodine, dodemorph, fenpropimorph, fenpropidin, guazatine, iminoctadine, spiroxamine, tridemorph,
anilinopyrimidines, such as pyrimethanil, mepanipyrim or cyprodinil,
antibiotics, such as cycloheximide, griseofulvin, casugamycin, natamycin, polyoxin or streptomycin,
azoles, such as bitertanol, bromoconazole, cyproconazole, difenoconazole, dinitroconazole, fenbuconazole, fluquinconazole, flusilazole, hexaconazole, imazalil, myclobutanil, penconazole, propiconazole, prochloraz, prothioconazole, tebuconazole, triadimefon, triadimenol, triflumizole, triticonazole, 5-chloro-7-(4-methylpiperidin-1-yl)-6-(2,4,6-trifluorophenyl)-[1,2,4]triazolo[1,5-a]pyrimidine,
dicarboximides, such as iprodione, myclozolin, procymidone, vinclozolin,
dithiocarbamates, such as ferbam, nabam, maneb, mancozeb, metam, metiram, propineb, polycarbamate, thiram, ziram, zineb,
heterocyclic compounds, such as anilazine, benomyl, boscalid, carbendazim, carboxin, oxycarboxin, cyazofamid, dazomet, dithianon, famoxadone, fenamidone, fenarimol, fuberidazole, flutolanil, furametpyr, isoprothiolane, mepronil, nuarimol, probenazole, proquinazid, pyrifenox, pyroquilon, quinoxyfen, silthiofam, thiabendazole, thifluzamide, thiophanate-methyl, tiadinil, tricyclazole, triforine,
copper fungicides, such as Bordeaux mixture, copper acetate, copper oxychloride, basic copper sulfate,
nitrophenyl derivatives, such as binapacryl, dinocap, dinobuton, nitrophthalisopropyl,
phenylpyrroles, such as fenpiclonil or fludioxonil,
sulfur,
other fungicides, such as acibenzolar-5-methyl, benthiavalicarb, carpropamid, chlorothalonil, cyflufenamid, cymoxanil, diclomezine, diclocymet, diethofencarb, edifenphos, ethaboxam, fenhexamid, fentin acetate, fenoxanil, ferimzone, fluazinam, fosetyl, fosetyl-aluminum, iprovalicarb, hexachlorobenzene, metrafenone, pencycuron, propamocarb, phthalide, toloclofos-methyl, quintozene, zoxamide,
strobilurins, such as azoxystrobin, dimoxystrobin, fluoxastrobin, kresoxim-methyl, metominostrobin, orysastrobin, picoxystrobin, pyraclostrobin or trifloxystrobin,
sulfenic acid derivatives, such as captafol, captan, dichlofluanid, folpet, tolylfluanid,
cinnamides and analogous compounds, such as dimethomorph, flumetover or flumorph.

The further fungicides are preferably selected from the group consisting of prochloraz, triticonazole, 5-chloro-7-(4-methylpiperidin-1-yl)-6-(2,4,6-trifluorophenyl)-[1,2,4]triazolo[1,5-a]pyrimidine, dimoxystrobin, pyraclostrobin, kresoxim-methyl, fenpropimorph and metrafenone.

If metconazole and epoxyconazole are employed in combination with further fungicides, they are preferably used jointly with one or two further fungicides.

In a preferred embodiment for field applications, i.e. application to living plants or plant parts thereof, metconazole and epoxyconazole are used in the form of an aqueous spray liquor. Application is preferably by spraying. Here, the spray liquor is applied either to the entire above-ground part of the plant or else only to individual plant parts. The choice of the individual plant parts to which the spray liquor is to be applied depends on the plant species and on its development stage. Application is preferably to the entire above-ground part of the plant or else to the parts which require particular protection against toxin contamination or which are preferably infected by trichothecene-forming fungi.

In general, in the case of field application, metconazole and epoxyconazole are employed in a total amount of from 10 to 1000 g/ha, preferably from 10 to 600 g/ha and particularly preferably from 20 to 450 g/ha per application.

Specifically, it is preferred under field conditions to use the following amounts of active substance per application:
metconazole (I): preferably from 5 to 500 g/ha; particularly preferably from 5 to 300 g/ha; in particular from 10 to 200 g/ha.
epoxyconazole (II): preferably from 5 to 600 g/ha; particularly preferably from 5 to 400 g/ha; in particular from 10 to 300 g/ha.

Per season, metconazole and epoxyconazole are preferably applied 1 to 5 times, particularly preferably 1 to 3 times and especially once or twice.

The present invention furthermore provides a method for reducing or preventing the contamination of cereal with mycotoxins formed by trichothecene-producing fungi, where the cereal is treated with metconazole in combination with epoxyconazole. Finally, the present invention also provides a method for reducing or preventing the contamination of cereal with mycotoxins formed by trichothecene-producing fungi, where the cereal is treated with a composition comprising metconazole and epoxyconazole.

For the amount and manner in which metconazole and epoxyconazole are employed, and for mycotoxins and the fungi producing them, reference is made to what has been said above.

The combined use of metconazole and epoxyconazole has a synergistic effect on the contamination of cereal with trichothecene toxins and other mycotoxins which originate from trichothecene-producing harmful fungi. “Synergistic action” means that the action on the contamination of at least one cereal species with at least one trichothecene toxin or at least one other mycotoxin originating from a trichothecene-producing harmful fungus is increased in a superadditive manner. In this manner, contamination with these mycotoxins is reduced considerably more effectively than would have been anticipated based on the activity of the individual active compounds. Expected efficacies of active compound combinations can be determined, for example, using Colby's formula (S. R. Colby, Calculating Synergistic and Antagonistic Response of Herbicide Combinations, Weeds, 15, pp. 20-22).

The examples below are intended to illustrate the invention, but without limiting it.

### EXAMPLES

### 1. Reduction of the Contamination of Wheat Grains with Deoxynivalenol (DON) after Treatment with Metconazole and Epoxyconazole Under Field Conditions

At growth stage GS 25-29 (tillering), outdoor winter wheat of the cultivar “Ritmo” was inoculated with rye grains infected with Fusarium sp. The active compounds were applied at growth stage GS 63 (beginning of flowering). Both metconazole and epoxyconazole were used as finished formulations (metconazole: trade name “Caramba”; epoxyconazole: trade name “Opus”; metconazole as SL=suspensible liquid; epoxyconazole as SC=suspensible concentrate). These formulations were diluted with water to the desired concentration, and the plants were treated by spraying with these diluted preparations. The active compounds were applied jointly as a tank mix. For comparison, the individual fungicides were also only employed on their own. Three weeks after application, the infection of the ears with Fusarium fungi was determined visually. The wheat grains were harvested and the DON content of the grains was determined after extraction and analysis by HPLC/MS. For comparative evaluation, the Fusarium infection and the DON value found for untreated wheat were defined as 100%. An effect on infection of 0% corresponds to the same infection as in the untreated control, an efficacy of 100% corresponds to 0% infection. A reduction of the DON content of 0% corresponds to the same DON content as in the untreated control, a reduction of 100% corresponds to a DON content below the detection limit. The values found for treated wheat are stated in table 1 as relative values, i.e. as a percentage based on this 100%. The expected efficacies for active compound combinations were determined using Colby's formula (S. R. Colby, Calculating Synergistic and Antagonistic Responses of Herbicide Combinations, Weeds, 15, pages 20-22, 1967) and compared with the observed efficacies.

TABLE 1

| | | | | | | Expected |
|---|---|---|---|---|---|---|
| | | | Effect on | | Reduction | reduction of |
| | Active | Application | infection | Expected | of DON | DON content |
| Ex. | compound | rate [g/ha] | [%] | effect [%]¹ | content [%] | [%]¹ |
| 1 | — | — | 0 | | 0² | |
| 2 | metconazole | 45 | 27 | | 33 | |
| 3 | epoxyconazole | 75 | 5 | | 0 | |
| 4 | metconazole + | 45 | 56 | 31 | 41 | 33 |
| | epoxyconazole | 75 | | | | |

¹according to Colby
²DON content of the grains of untreated wheat: 33.7 mg/kg

As can be seen from the results, the combined use of metconazole and epoxyconazole results in a synergistic effect both on the Fusarium infection of wheat and on the DON content of the harvested grains.

1. The use of metconazole in combination with epoxyconazole for reducing or preventing the contamination of cereal with toxins formed by trichothecene-producing fungi.

2. The use of a composition comprising metconazole and epoxyconazole for reducing or preventing the contamination of cereal with toxins formed by trichothecene-producing fungi.

3. The use according to claim 1, where the trichothecene-producing fungi are those from the genera Fusarium, Trichoderma or Stachybotrys.

4. The use according to claim 1, where the toxins are trichothecenes or zearalenone.

5. The use according to claim 4, where the trichothecenes comprise at least one of the following substances: deoxynivalenol, nivalenol, 3- and 15-acetoxynivalenol, T-2 toxin, HT-2 toxin, neosolaniol, monoacetoxyscirpenol, diacetoxyscirpenol, 15-acetoxyscirpendiol, fusarenon, T-2 tetraol or verrucarol.

6. The use according to claim 1, where the cereal is selected from the group consisting of wheat, barley, rye, triticale, oats, rice and corn.

7. The use according to claim 1, where metconazole and epoxyconazole are employed in a ratio of from 10:1 to 1:10.

8. A method for reducing or preventing the contamination of cereal with mycotoxins formed by trichothecene-producing fungi, where the cereal is treated with metconazole in combination with epoxyconazole.

9. A method for reducing or preventing the contamination of cereal with mycotoxins formed by trichothecene-producing fungi, where the cereal is treated with a composition comprising metconazole and epoxyconazole.

10. The method according to claim 8, where metconazole and epoxyconazole are employed in a ratio of from 10:1 to 1:10.

11. The method according to claim 9, where metconazole and epoxyconazole are employed in a ratio of from 10:1 to 1:10.
